(19) United States
(12) Patent Application Publication
(10) Pub. No.: US 2012/0319887 A1
(43) Pub. Date: Dec. 20, 2012

(54) BICONIC RADAR REFLECTOR

(76) Inventor: Morris RATLIFF, Gulf Breeze, FL (US)

(21) Appl. No.: 13/164,702

(22) Filed: Jun. 20, 2011

(51) Int. Cl. H01Q 15/18

(52) U.S. Cl. 342/7

(57) ABSTRACT

A biconic radar reflector permits boats to be seen on large ship radars. The biconic radar reflector may give a continuous azimuth lobe and a wide elevation lobe in order to maximize the probability of being seen on a ship radar.

The biconic radar reflector may give a solid 360 degree azimuth lobe and a wide 80 degree elevation lobe. The biconic radar reflector may give improved detection probability, as compared to conventional corner reflectors, especially in the case of heavy rain clutter, where right circular return is 20 dB over the rain clutter. The biconic radar reflector may be made of two truncated conic sections, facing each other along a vertical axis so that a 90 degree angle is between them.

### BACKGROUND OF THE INVENTION

The present invention, relates to boating radar devices and, more particularly, to a biconic radar reflector to maximize the probability of a boat being seen on large ship radars.

Small wooden or fiberglass boats have a need to be seen on large ship radars. Boats made of these materials have a low radar cross section (RCS) which makes small, non-metal vessels difficult to see on large vessel radars. At night, and in heavy weather, this presents the danger that large vessels will run over small boats.

Currently, these boats may use a cluster of corner reflectors which gives a “spikey” lobing pattern of eight lobes with deep nulls between. These nulls may be both in azimuth and elevation. Moreover, these conventional corner reflectors do not offer rain clutter rejection for circular polarization. Conventional corner radar reflectors do not have a strong right circular return for right circular incident waves.

As can be seen, there is a need for a radar reflector that may provide a strong radar cross-section without various azimuth and elevation nulls, while cutting through rain and sea clutter.

### SUMMARY OF THE INVENTION

In one aspect of the present invention, a biconic radar reflector comprises a first truncated conical section; a second truncated conical section attached to the first truncated conical section such that an angle of about 90 degrees is formed between the first truncated conical section and the second truncated conical section.

In another aspect of the present invention, a method for reflecting radar waves comprises disposing a biconic radar reflector on a boat, the biconic radar reflector having a first truncated conical section and a second truncated conical section attached to the first truncated conical section such that an angle of about 90 degrees is formed between the first truncated conical section and the second truncated conical section.

These and other features, aspects and advantages of the present invention will become better understood with reference to the following drawings, description and claims.

### BRIEF DESCRIPTION OF THE DRAWINGS

FIG. 1 is a perspective view of a boat having a biconic radar reflector according to an exemplary embodiment of the present invention;

FIG. 2 is a perspective view of the biconic radar reflector of FIG. 1;

FIG. 3 is a cross-sectional view taken along line 3-3 of FIG. 2;

FIG. 4 is a side view of the biconic radar reflector of FIG. 1;

FIG. 5 is a graph showing echo levels at various elevations as provided by the biconic radar reflector of FIG. 1; and

FIG. 6 is a graph showing radar cross sections of a perfectly conducting sphere normalized to the optics value πa² or πd²/4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a biconic radar reflector that may permit boats to be seen on large ship radars. The biconic radar reflector may give a continuous azimuth lobe and a wide elevation lobe in order to maximize the probability of being seen on a ship's radar. The biconic radar reflector may give a solid 360 degree azimuth lobe and a wide 80 degree elevation lobe. The biconic radar reflector may give improved detection probability, as compared to conventional corner reflectors, especially in the case of heavy rain clutter, where right circular return is 20 dB over the rain clutter. The biconic radar reflector may be made of two truncated conic sections, facing each other along a vertical axis so that a 90 degree angle is between them.

Most marine radars are linearly (vertical) polarized. Some marine radars are circularly polarized. In the presence of heavy rain clutter, circular opposite sense polarization (OP) (right circular, RC) radar returns will cut through rain and sea clutter. The biconic radar reflector of the present invention will show up on OP ships plan position indicator (PPI) displays.

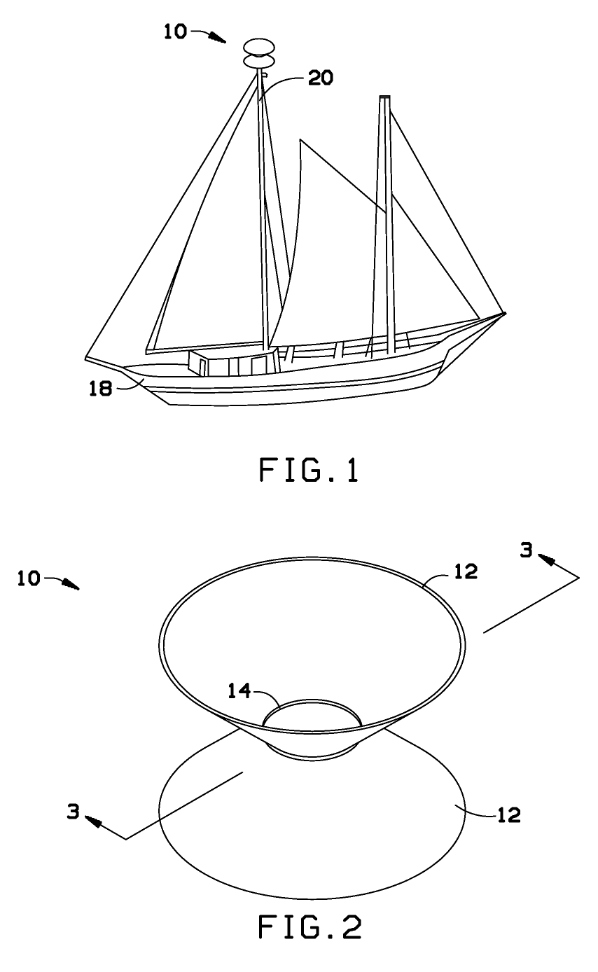

Referring to FIG. 1, a biconic radar reflector 10 may be mounted on a mast 20 of a boat 18. In some embodiments, the biconic radar reflector 10 may be covered by a circular flat plate, which can mount other devices, such as riding lights, GPS antenna, (with choke rings), a windvane and an anemometer, without affecting the radar reflector signature.

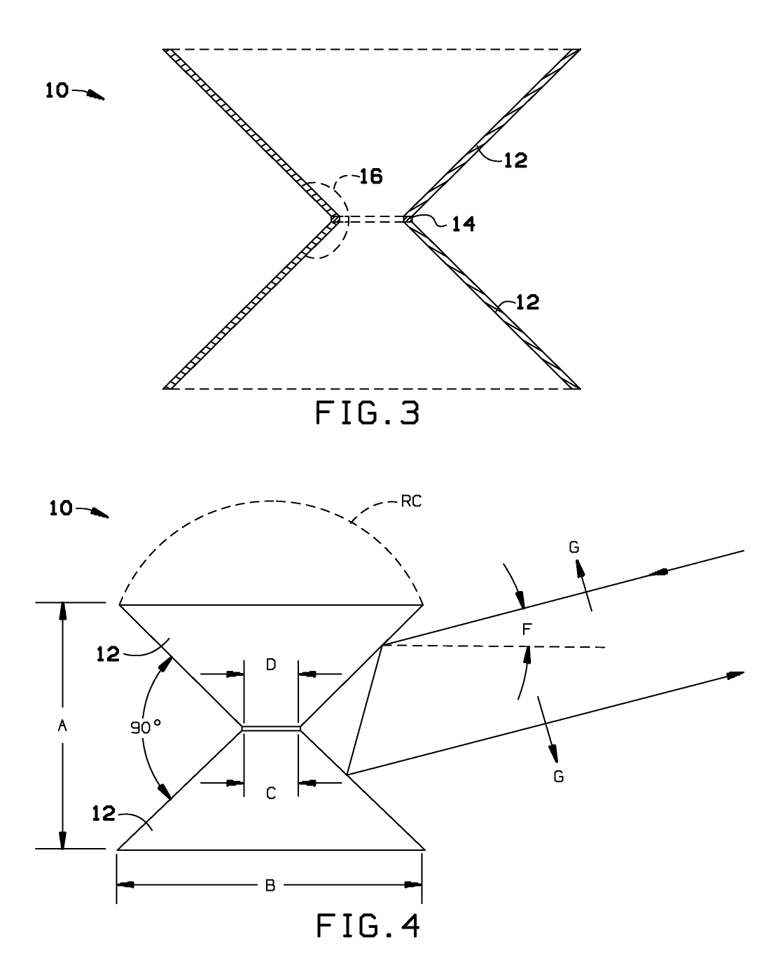

Referring to FIGS. 2 through 4, the biconic radar reflector 10 may include first and second truncated conical sections 12 that may face each other along a vertical axis such that a 90 degree angle may be formed between the sections 12. The sections 12 may be made of a highly conductive material, such as aluminum, copper or the like. The horizontal lobe from the biconic radar reflector 10 may be an isoazimuthal (doughnut) shaped lobe which covers a full 360 degrees of azimuth space.

Incident radar waves may be incident on the biconic radar reflector 10 at an elevation F, as shown in FIG. 4. The incident waves (such as incident right circular polarized waves) may strike the upper conic, reflect to the lower conic as left circular polarized waves, and may reflect back to the radar as right circular polarized waves.

A quarter wavelength insulator 14 may be disposed between the truncated conical sections 12. The quarter wavelength insulator 14 may have a thickness of about ¼ inch. An open-ended section of a long transmission line (not shown) may be connected to each conical section 12 to provide a “ringing” effect that may be seen on the ship PPI scope, thereby enhancing the probability of the radar reflector being seen.

As shown in FIG. 5, the biconic radar reflector 10 may be operable at a variety of elevations (F, see FIG. 4) for the incident waves. Acceptable echo levels (in dB) may be obtained at elevations up to about 40 degrees, creating a wide (80 degrees) elevation lobe. This elevation lobe may be large enough to allow a wide roll motion on the boat while still being visible to a ship's radar.

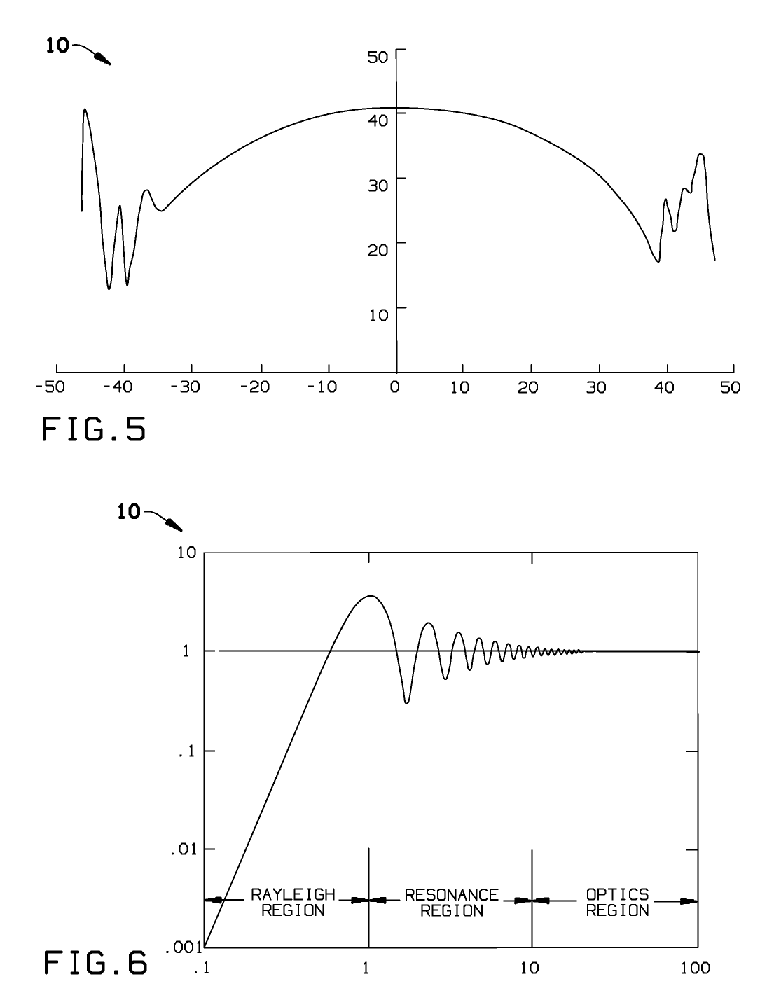

As shown in FIG. 6, the size of the biconic radar reflector 10 may be chosen to have a diameter C (see FIG. 4) of about 12 inches, which will give Pid>30 times wavelength to put the target into the optics region at 10 gigahertz (GHz). A small diameter C, D of 12 inches and a large diameter of 28 inches will result in a dimension A of 16 inches. The small diameter of 12 inches and the large diameter of 28 inches will compute, at 10 Ghz, to provide a Radar Cross section of +22.3 dbSM (decibels above one square meter) or 169.2 square meters, or an area 13 meters on a side. This is the area of a barn, and will show up on a ship's PPI. Ten Ghz is in the middle of the X-Band range of 8 Ghz to 12 Ghz in the Marine Radar Band.

The biconic radar reflector 10 described above may typically be used as a passive device. However, the biconic radar reflector 10 may be used as an active transmission antenna by attaching an active radar transmitter or a radar beacon to the device.

It should be understood, of course, that the foregoing relates to exemplary embodiments of the invention and that modifications may be made without departing from the spirit and scope of the invention as set forth in the following claims.

What is claimed is:

1. A biconic radar reflector comprising:
a first truncated conical section;
a second truncated conical section attached to the first truncated conical section such that an angle of about 90 degrees is formed between the first truncated conical section and the second truncated conical section.

2. The biconic radar reflector of claim 1, further comprising a wavelength insulator disposed between the first truncated conical section and the second truncated conical section.

3. The biconic radar reflector of claim 1, wherein a small diameter of the first and second truncated conical sections is selected at about 10 times an anticipated incident wavelength.

4. The biconic radar reflector of claim 1, wherein the biconic radar reflector is made of a conductive material.

5. The biconic radar reflector of claim 4, wherein the conductive material is aluminum or copper.

6. The biconic radar reflector of claim 1, wherein a small diameter of the first and second truncated conical sections is selected to avoid resonance and be in an optics region.

7. A method for reflecting radar waves, comprising:
disposing a biconic radar reflector on a boat, the biconic radar reflector having a first truncated conical section and a second truncated conical section attached to the first truncated conical section such that an angle of about 90 degrees is formed between the first truncated conical section and the second truncated conical section.

8. The method of claim 7, further comprising positioning a quarter wavelength insulator between the first truncated conical section and the second truncated section.

9. The method of claim 7, wherein the biconic radar reflector has an elevation lobe of about +/−40 degrees about horizontal and an continuous 360 degree isoazimuthal lobe.
